(19) United States
(12) Patent Application Publication
(10) Pub. No.: US 2016/0275026 A1
(43) Pub. Date: Sep. 22, 2016

(54) WEAKLY ORDERED DOORBELL

(71) Applicant: INTEL CORPORATION, Santa Clara, CA (US)

(72) Inventors: Niall MCDONNELL, Limerick (IE); Tomasz KANTECKI, Ennis (IE); Ryan CARLSON, Hillsboro, OR (US); Michael O'HANLON, Limerick (IE)

(21) Appl. No.: 14/663,785

(22) Filed: Mar. 20, 2015

(51) Int. Cl. G06F 13/28; G06F 13/16; G06F 12/10; G06F 12/08; G06F 12/12

(52) U.S. Cl. CPC G06F 13/28; G06F 12/0833; G06F 12/128; G06F 12/1081; G06F 13/1673; G06F 2212/62; G06F 2212/69; G06F 2212/656

(57) ABSTRACT

A weakly ordered doorbell at least reduces the cycle cost of talking to a device. This may manifest as simple performance improvement, but it also allows a reduction in the number of jobs batched into a single doorbell—current DPDK (Data Plane Development Kit) code (for example) batches larger numbers of packets behind a single doorbell to amortize the per-packet doorbell cost. Reducing the number of packets at least provide a better latency profile.

### TECHNICAL FIELD

And exemplary aspect relates to processors. In particular, in one exemplary embodiment, one aspect is directed toward processors and memory, as well as techniques for managing the passing of work from a CPU to one or more direct memory access capable device(s). Even more specifically, embodiments relate to the use of a weakly ordered doorbell such that subsequent writes from a logical core are allowed to progress without waiting for the doorbell store to complete.

### BACKGROUND

Processors are commonly operable to perform instructions to access memory and perform one or more computations. For example, processors may execute load instructions to load or read data from memory and/or store instructions to store or write data to memory, to facilitate various computational processes, and the like. Additionally, processors are capable of executing one or more applications to, for example, solve problems, analyze data, provide entertainment, and the like.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary doorbell sequence;

FIG. 2 illustrates an exemplary hardware diagram to implement the weakly ordered doorbell;

FIG. 3 illustrates an exemplary delay period;

FIG. 4 illustrates an exemplary new instruction;

FIG. 5 illustrates an exemplary new instruction in greater detail;

FIG. 6 illustrates an exemplary embodiment of a WCB eviction control logic;

FIG. 7 illustrates an exemplary multi-core architecture with the weakly ordered doorbell;

FIG. 8 illustrates another exemplary embodiment of an implementation of a technique disclosed herein within a processor environment;

FIG. 9 illustrates another exemplary embodiment of an implementation of a technique disclosed herein within a processor environment;

FIG. 10 another exemplary embodiment of an implementation of a technique disclosed herein within a processor environment;

FIG. 11 illustrates another exemplary embodiment of an implementation of a technique disclosed herein within a processor environment;

FIG. 12 illustrates another exemplary embodiment of an implementation of a technique disclosed herein within a processor environment; and

FIG. 13 illustrates another exemplary embodiment of an implementation of a technique disclosed herein within a processor environment.

### DESCRIPTION OF EMBODIMENTS

In a computing environment, there is a de facto standard way of passing work (instructions) from a central processing unit (CPU) to a direct memory access (DMA) capable device. Typically, the CPU creates data structures called descriptors and stores these descriptors in a memory ring (e.g., a circular buffer). The CPU inserts at one location (usually denominated the “tail”) which the device pulls descriptors off of at the other end (i.e., the “head”).

After creating descriptors, the CPU modifies the tail address and notifies a device of the modified tail address. This is achieved by delivering a “doorbell” to the device, which amounts to writing a memory map I/O mapped doorbell configuration space register (CSR) in the device. This can typically be a 4-8B write.

The doorbell write typically has to obey the same memory write ordering rules as writes to ‘normal’ memory. As a result, as a result, the doorbell incurs a cycle cost related to maintaining store ordering. The exact cost varies with usage, but it is not insignificant for fine grain offload.

In accordance with the one exemplary embodiment discussed herein, a weakly ordered (streaming) write is disclosed that offers various improvements over prior doorbell technology.

One of the problems with existing UC (uncacheable) writes is that the write creates a “shadow” during which the microprocessor core is waiting for a GO (Globally Observable) indicator, where during this period no subsequent stores can be drained.

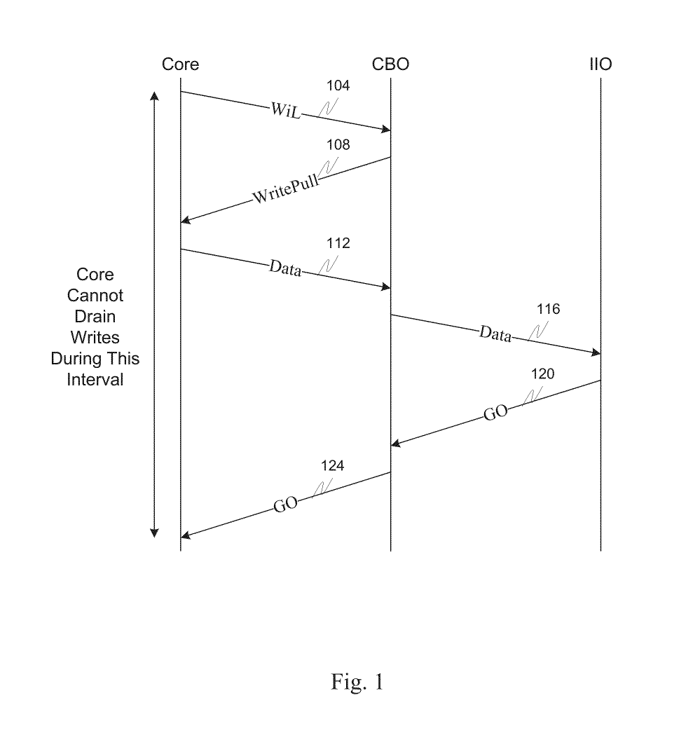

For example, as illustrated in FIG. 1, there is a period or interval during which the core cannot drain writes. More specifically, as illustrated in FIG. 1, there is a shadow, during which six operations occur between the core, caching agent (CBO) (or address decoder) and the integrated I/O (IIO) (or shared queue to device). These operations include the WiL 104, writepull 108 (or get write data), a data transfer 112 from the core to the CBO, a data transfer 116 from the CBO to the IIO, globally observable message 120 sent from the IIO to the CBO, and in turn the globally observable message 124 sent from the CBO to the core. This period during which the core is waiting for the GO message can be referred to as a “shadow,” with the time period represented by this shadow capable of being absorbed to some extent by the store buffers in the core. However, the core will eventually stall out when the store buffers are full. This manifests itself as a “cycle cost” for issuing the doorbell, and it is quite significant in embedded usages, such as packet processing, that are highly optimized.

One exemplary aspect addresses this lengthy shadow, and provides a solution with a shorter time period before a next write, which results in a lower cycle cost for the core communicating with devices, such as direct memory access devices. An exemplary methodology for implementing this technique is utilizing a weakly ordered write that will not impede subsequent writes.

It is also possible to map the doorbell as WC (write-combining) WC is a memory type where multiple writes to the same address are allowed to aggregate into full cache lines before being sent to the system bus. WC writes are weakly ordered, and as such, do not incur the same costs as a UC write. However, there are a number of significant issues that arise from using WC, notably:

Ensuring doorbell progress, as an 8B WC write may remain indefinitely in a WCB (write-combining buffer). Fencing the write to ensure progress will incur costs similar to the original UC costs. Memory fences inhibit the reordering of memory accesses in modern microprocessors. Fences are useful to implement synchronization and strong shared memory semantics in multi-threaded programs. Fencing in general is a serializing operation that guarantees that every load and store instruction that proceeds a fence instruction in program order becomes globally observable before any load or store instruction that follows the fence instruction.

Speculative reads can occur to WC mapped addresses.

It is not possible to synchronize the ordering of doorbells across different cores.

WC doorbells are used, for example, in various processor architectures, but these are all typically 64B in nature in order to solve the first issue illustrated above. This is not the most bandwidth efficient solution as an exemplary embodiment does not require a 64B doorbell. Typically the embodiments described herein can utilize an 8B doorbell with sufficiency. Another complication is that some microprocessor vendors do not architecturally guarantee automicity for 64B writes, which can provide further complications.

The second issue identified above could be resolved by simply ensuring no reads to the doorbell area have side effects, but this constrains the device memory map, and may rule out many existing devices.

Again, an exemplary embodiment discussed herein can resolve one or more of the issues highlighted above.

More specifically, a new instruction with the following behavior is described:
In accordance with an exemplary embodiment, the instruction is an 8B write (4 or 16B (or other size) versions could also be useful).
The instruction is issued as weakly ordered regardless of the type of the underlying memory region.
The instruction exits the write combining buffer automatically at the earliest possible opportunity (unlike a normal WC mapped or non-temporal 8B write). Therefore, once the WC buffer is allocated and filled with the 8B value, it can be immediately available for eviction (in the same manner as a full WCB would be today).

Current APIs for talking to the exemplary I/O devices involve:
Creation of one or more “request” descriptors destined for the I/O devices. Currently these descriptors are created in WB (write back) open memory as part of a ring structure, where the processor architecture is adding descriptors at the “tail” while the I/O device is reading them at the “head.”
A memory mapped I/O (MMIO) write acting as a “doorbell” is configured to alert the I/O device to the presence of new descriptors.

In accordance with the one exemplary embodiment, the code can include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| Store_DB | <UC> | ; Doorbell, write to MMIO UC space |

As noted above, the code executed subsequent to this typically is not under the applicant's control. If the subsequent code contains sufficient writes to fill the available store buffers during the “UC shadow” described above, the core will stall.

A new instruction replaces the existing UC store as follows:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering |

One should note that even though the memory type (optionally derived from PAT/MTRR or memory type of doorbell location) of the doorbell location is UC, the instruction executes as weakly ordered. This is necessary to allow the instruction to be used with devices having arbitrary layouts of CSRs (what most devices have today). If the memory area containing the doorbell was mapped as WC, speculative reads might occur, which could have fatal side effects. Memory type for a region of memory comes from 2 sources: MTRR—Memory Type Range Registers—These specify wide regions of memory to a specific memory type and PAT—Page Attribute Table—The PAT works on a page granularity (4 kB, or 2 MB/4 MB regions). When a processor is determining a memory type for a particular request the processor looks of both the MTRR's and the PAT and uses the most conservative (in general) of the two. For example, take the scenario of sending a load to address x out to memory. The MTRR's say the region is WB, but the PAT says the load is going to UC memory. The PAT “wins” since UC is more conservative than WB memory and the load is marked as UC.

One should also note that even though the 8B write is weakly ordered, the 8B write will not “stick” in a WCB like today's weakly ordered writes.

Furthermore, because the doorbell is weakly ordered, an SFENCE was added beforehand to ensure that the doorbell could not “pass” the descriptors and become visible before some/all descriptors.

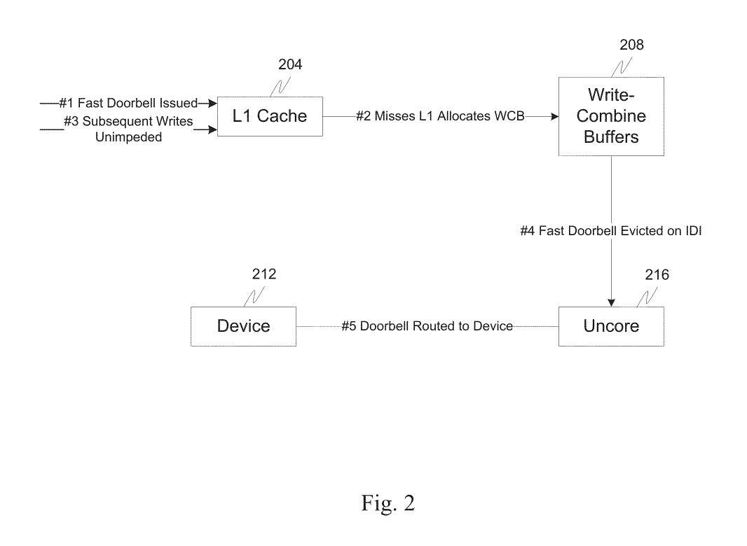

FIG. 2 shows an exemplary hardware implementation of the above exemplary weakly ordered doorbell techniques. One assumption is that the doorbell address is mapped as UC. Since UC addresses are never cached, an L1 miss is guaranteed. A WCB is allocated, and it is immediately available for eviction. However, unlike a UC store today, the doorbell is weakly ordered so subsequent writes from the logical core are allowed to progress without waiting for the doorbell store to complete.

As illustrated in FIG. 2 the architecture includes: an L1 cache 204, write-combined buffers 208, a device, such as a DMA device 212 and an uncore 216. The uncore is used to describe the functions of a microprocessor that are not in the core, but which are essential for core performance. The core contains the components of the processor involved in executing instructions, including the ALU, FPU, L1 and L2 cache. Uncore functions include, for example, the QPI controllers, L3 cache, on-die memory controller and, for example, the Thunderbolt® Controller. Other bus controllers (not shown) such as PCI Express and SPI are typically part of the chipset. The micro architecture of the uncore 216 is typically broken down into a number of modular units. The main uncore interface to the core is referred to as a cache box (CBOX) which interfaces with the last level cache (LLC) and is responsible for managing cache coherency. Multiple internal and external QPI links are managed by the physical layer units, referred to as PBox. Connections between the PBox, CBox, (bridges or switches) and one or more iMC's (MBox) are managed by a system configuration controller and a router.

In FIG. 2, in a first step, a fast doorbell is issued, which is received by the L1 cache 204. Next, and as discussed, since UC addresses are never cached, and an L1 miss is guaranteed within step 2, the L1 allocates a write-combined buffer, which becomes immediately available for eviction. In step 3, subsequent writes are allowed to progress to the L1 cache 204, with the write combined buffer 208 in step 4, evicting the fast doorbell on the in-die interconnect (IDI) to the uncore 216. The uncore 216 then routes, in step 5, the doorbell to the device 212. (Please note that technically the L1 cache does not receive the doorbell write. Since it is a non-cacheable write, the L1 is not checked.)

As noted above, it was not possible to synchronize the ordering of doorbells across different cores. Thus, the following consequences are encountered:
If only one agent is writing to the doorbell, there are no issues, an existing tail pointer update mechanism can work. This is the case for most applications.
If two or more agents are writing to the doorbell, the expectation is that the agents need to synchronize their accesses to a shared descriptor area. The agents need to maintain a local shared tail pointer copy. However, existing tail pointer update mechanisms are not safe as they are an absolute value, therefore requiring a fence (which will cost as much as the UC write).
A relative tail pointer update (where the doorbell includes writing an incremental number of created descriptors rather than an absolute value) could be utilized for a shared queue. This would need the device to understand a relative tail pointer update.

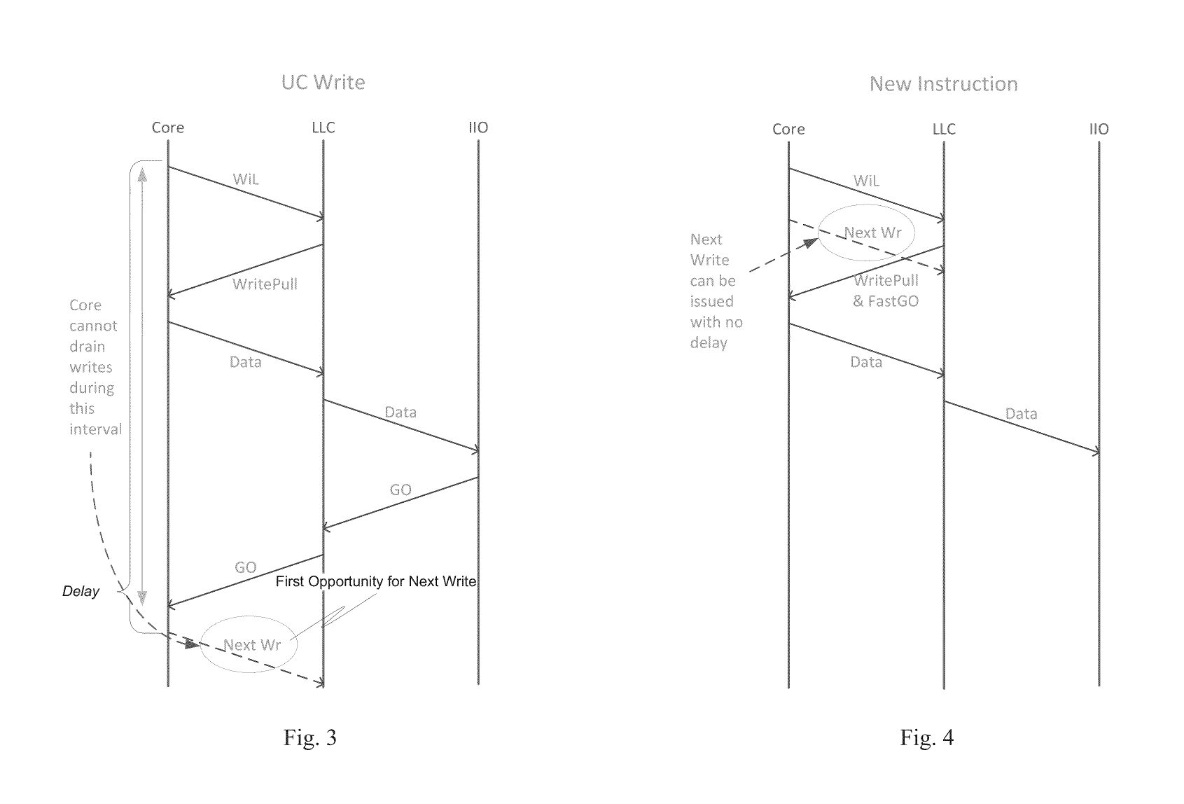

FIG. 3 illustrates with more specificity one problem with current techniques. As in FIG. 1 there is a “shadow” period where the core is unable to drain writes. As seen in FIG. 3, the first time available for the core to drain writes (shown as Next Wr) occurs after the core receives the GO from the LLC.

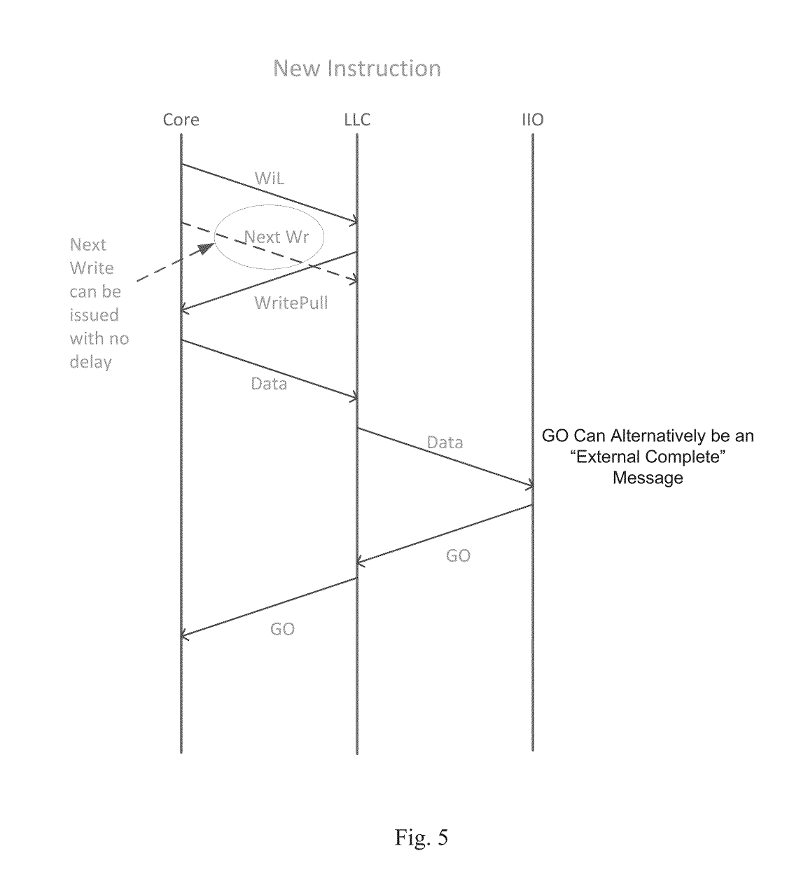

Compare FIG. 3 to FIG. 4. As shown in FIG. 4, an exemplary implementation of the new weakly ordered doorbell technique is illustrated. Specifically, as shown in FIG. 4, the next write (Next Wr) can begin without substantial delay. Here, the next write is shown commencing after the WiL and before the WritePull and FastGO are received by the core. (WiL is a Write Invalidate Line that is essentially a memory write transaction. WiL tells the uncore that a core is writing memory and to tell all other cores/agents that might have that data in their caches to invalidate the cached copies. Like FastGO and ExtCmp, WiL is an Intel® specific. An alternative manner of expressing this feature is “memory write” or “write command.”) In this exemplary embodiment, the FastGO and ExtCmp (External Complete—See FIG. 5) messages are Intel® specific constructs. The FastGO enables the core to de-allocate the internal buffers used by the doorbell (specifically, the WCBs). The “next write” doesn't have to wait for the FastGO of the doorbell, but FastGo does allow resources (like the WCB's) to be reclaimed so other writes can use them. The ExtCmp is the real GO point for the doorbell (analogous to the GO message seen on a UC store), when everything else in the system can see that the doorbell write has occurred. The core still should be informed when this happens for store-ordering purposes.

FIG. 5 provides a more complete picture of an exemplary embodiment of the new instruction. Here, after the next write, a writepull is sent from the LLC to the core. Next, data is sent from the core to the LLC, and in turn to the IIO. The IIO returns a GO/ExtCmp to the LLC which is in turn forwarded to the core.

As in FIGS. 4 and 5, the next write can occur after WiL and thus not suffer the delay as experienced in current implementations.

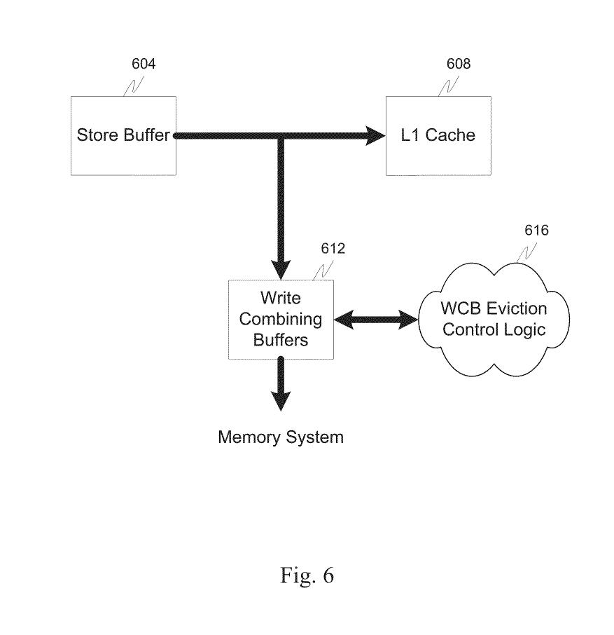

FIG. 6 illustrates a high-level diagram of an exemplary architecture which can implement the techniques herein. In particular, FIG. 6 includes a store buffer 604, and L1 cache 608, write combining buffers 612, WCB eviction control logic 616, and a memory system. This store buffer 604 holds all stores until they are cleared to write their data into memory. The write combining buffers 612 hold data from the stores (that either miss the cache or the store's data is uncacheable) so the data from multiple stores can be coalesced into a single write to memory. By doing this, the WCB achieves a performance increase by reducing the number of writes out to main memory. The WCB eviction control logic 616 includes the control logic that is in charge of this functionality. The control logic attempts to prevent the WCB from doing the write until the entire buffer is full, or the WCB is forced to be evicted by external forces. Examples would be all WCBs are in use, and another store wants one or the core is required to flush all store data to memory.

As discussed, an exemplary technique introduced herein provides a new type of store that changes the WCB eviction control. When this new type of store writes its data into a WCB, instead of preventing the WCB from writing to memory until more stores write into the WCB, the new technique and store will cause the WCB to be evicted immediately once the store has written the WCB.

Stores (writes to any location) get output from a core into a store buffer. This is effectively a first in first out (FIFO) of (address to write to, data to be written) couples. When the store is pulled from the store buffers, the address is checked against the L1 cache. If the address hits, store will be written to the L1 cache. If the store misses, the store will be allocated to the write combining buffer (WCB). One exemplary embodiment typically uses uncacheable (UC) stores to talk to other devices, such as a network interface card on a PCIe bus. Since UC writes are not cacheable by definition, they will always get a WCB. These UC writes will be eligible to be evicted from the WCB (to go to the location they are destined for) immediately.

However, stores must be observable in order. This means the newer stores in the store buffers cannot be processed by the core until it is verifiable that the UC store is “visible” to other cores in the system. This technique is referred to as globally observable (GO) as discussed above.

Once a UC store is issued to the memory sub-system, no other UC stores may be issued by the core until the first store is globally observable. Once the memory sub-system notifies the core that the first UC store has reached its GO point, the next UC store can be issued by the core. Due to the delay imposed by waiting for the GO, the interval between UC store issues is significant.

In a more specific embodiment, the UC store sheet shows that the UC store first goes to the LLC slice that “owns” the address, which then handshakes to pull the data. The UC store then pushes the data to an ordered queue in the I/O block that the address maps to (for example, a PCIe route port). Only then, can the LLC slice return the GO to the originating core to tell the originating core the UC write is visible to all and only then can that store start to pull more stores from the store buffers. This interval is again a significant amount of time in terms of CPU utilization, the reason for that can be seen in the CPU sheet, with these various entities all being read across the CPU die.

During this interval, the CPU core continues to execute, and since it will execute stores, the store buffer FIFO fills up. At this point, the CPU pipeline starts to back up and can eventually stall.

As discussed, the exemplary technique herein is directed toward a new instruction that is weakly ordered. This means the instruction does not have to obey the above rule regarding that the stores must be observable in order and that newer stores in the store buffers cannot be processed by the core until the UC store is visible to other cores in the system. Rather, in accordance with an exemplary embodiment, the newer stores can continue to be pulled from the store buffers without any delay. This at least translates to increased performance, and addresses the issue of the CPU stalling.

Another important aspect of the techniques disclosed herein is that the new instruction behaves in this matter despite the fact that the underlying address is mapped as UC. This can be important in terms of easing constraints on the address map of the device being written to, and working with older, legacy devices.

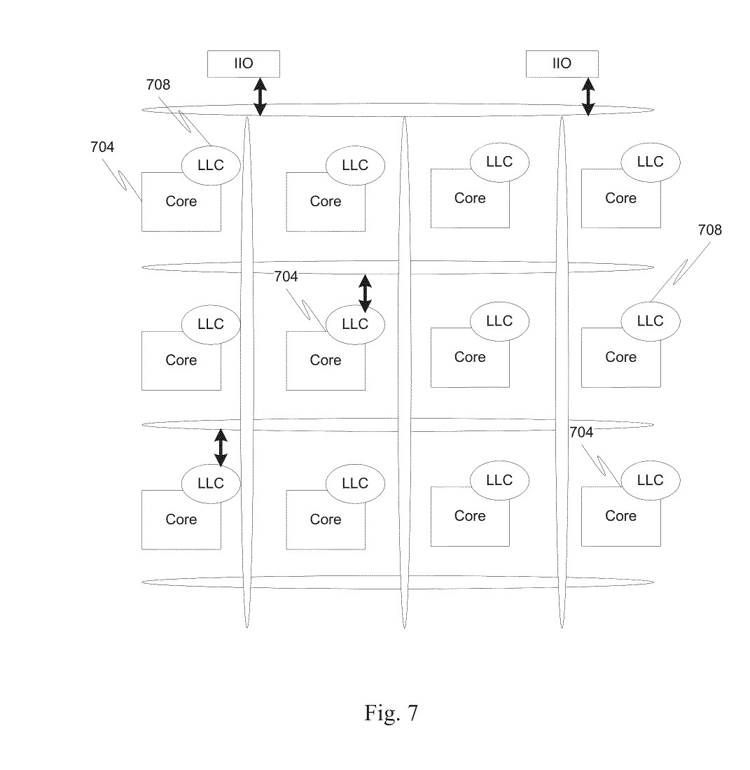

FIG. 7 illustrates an exemplary embodiment of a processor's core architecture. As illustrated in FIG. 4, there are multiple cores with associated LLCs 708. As shown in FIG. 7, the componentry illustrated in FIG. 6 can be included in one or more of the cores 704.

Embodiments are not limited to computer systems. Alternative embodiments of the present disclosure can be used in other devices such as handheld devices, wearable devices, embedded applications and the like. Examples of handheld devices include, but are not limited to, cellular phones, Internet Protocol devices, digital cameras, personal digital assistants (PDAs), and handheld PCs or computing devices. Embedded applications may include, but are not limited to, a micro controller, a digital signal processor (DSP), system on a chip (SoC), network computers (NetPC), set-top boxes, network hubs, wide area network (WAN) switches, or any other system that can perform one or more instructions in accordance with at least one embodiment.

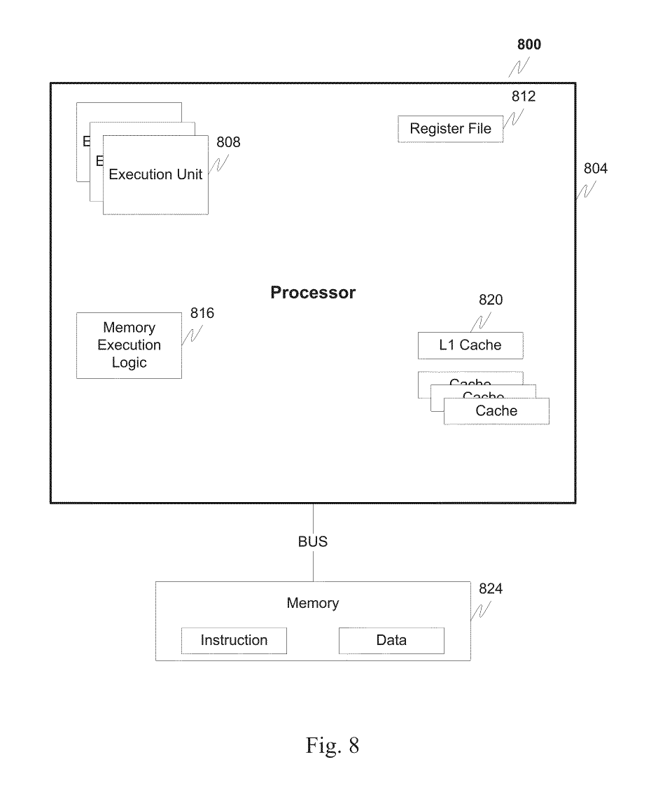

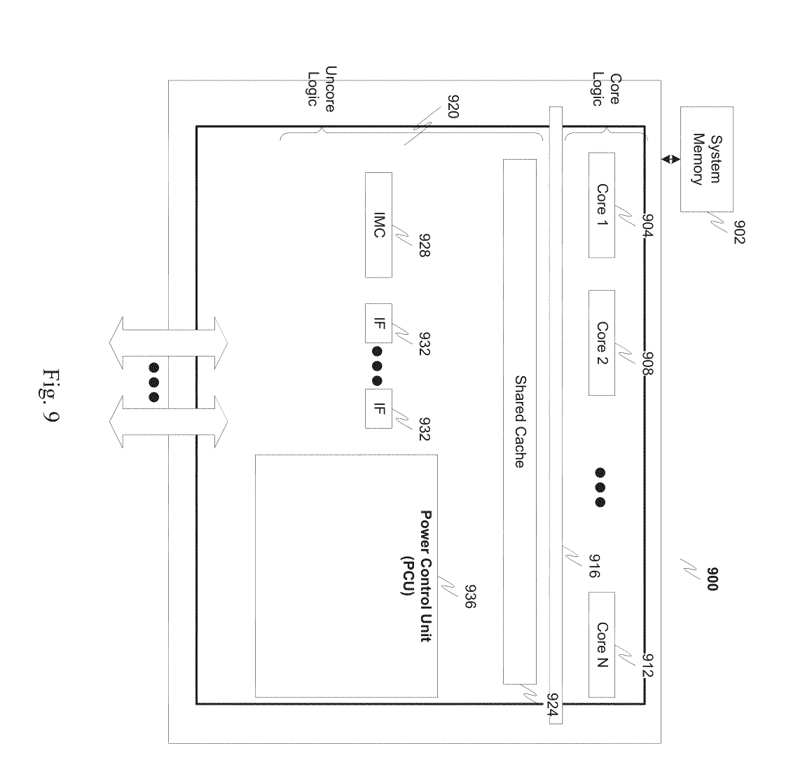

In the exemplary embodiment of FIG. 8, system 800 includes processor 804 which includes one or more execution units 808 to implement an algorithm(s) that is to perform at least one instruction. One embodiment may be described in the context of a single processor desktop or server system, but alternative embodiments may be included in a multiprocessor system. System 800 may be an example of a ‘hub’ system architecture. The computer system 800 includes a processor 804 to process data signals. The processor 804, as one illustrative example, includes a complex instruction set computer (CISC) microprocessor, a reduced instruction set computing (RISC) microprocessor, a very long instruction word (VLIW) microprocessor, a processor implementing a combination of instruction sets, an out of order based processor, or any other processor device, such as a digital signal processor, for example. The processor 804 is coupled to a processor bus (BUS) that transmits data signals between the processor 804 and other components in the system 800, such as main memory 824 configured to store instructions, data, or any combination thereof. The other components of the system 800 may include, but are not limited to, a graphics accelerator, a memory controller hub, an I/O controller hub, a wireless transceiver, a Flash BIOS, a network controller, an audio controller, a serial expansion port, and an I/O controller as well as other well known components. These elements perform their conventional functions that are well known to those familiar with the art and are not illustrated herein.

In one embodiment, the processor 804 includes a Level 1 (L1) internal cache memory 820. Depending on the architecture, the processor 804 may have a single internal cache memory or multiple levels of internal cache memories (e.g., L1 and L2) as shown. Other embodiments include a combination of both internal and external caches depending on the particular implementation and needs. Register file 82 is capable of storing different types of data in various registers including, but not limited to, integer registers, floating point registers, vector registers, banked registers, shadow registers, checkpoint registers, status registers, configuration registers, and instructions.

Execution unit(s) 808, include logic to perform integer and floating point operations. The execution unit(s) may or may not have a floating point unit. The processor 804, in one embodiment, includes a microcode (μcode) ROM to store microcode, which when executed, is capable of performing algorithms for certain macroinstructions or handle complex scenarios. Here, microcode is potentially updateable to handle logic bugs/fixes for processor 804. Alternative embodiments of an execution unit 808 may also be used in micro controllers, embedded processors, graphics devices, DSPs, and other types of logic circuits.

The system 800 also includes a main memory 824. Main memory 1424 may include, but is not limited to, a dynamic random access memory (DRAM) device, a static random access memory (SRAM) device, flash memory device, or other memory device. Main memory 824 is capable of storing instructions and/or data represented by data signals that are to be executed by the processor 804. The processor 804 is coupled to the main memory 824 via a processor bus. A system logic chip, such as a memory controller hub (MCH) may be coupled to the processor bus and main memory 824. An MCH can provide a high bandwidth memory path to memory 824 for instruction and data storage and for storage of graphics commands, data and textures. The MCH can be used to direct data signals between the processor 804, main memory 824, and other components in the system 800 and to bridge the data signals between processor bus, main memory 824, cache memory 820, and system I/O, for example. The MCH may be coupled to main memory 824 through a memory interface. In some embodiments, the system logic chip can provide a graphics port for coupling to a graphics controller through an Accelerated Graphics Port (AGP) or other graphics controller interconnect. The system 800 may also include an I/O controller hub (ICH). The ICH can provide direct connections to some I/O devices via a local I/O bus. The local I/O bus is a high-speed I/O bus for connecting peripherals to the main memory 824, chipset, and processor 804. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

As shown in FIG. 8, the componentry illustrated in FIG. 6 can be included in one or more of the cores/execution units 808 to realize the weakly ordered doorbell disclosed herein.

Referring now to FIG. 9, shown is a block diagram of an exemplary processor in accordance with an embodiment. As shown in FIG. 9, processor 900 may be a multicore processor including a plurality of cores 904-912. In one embodiment, each such core may be configured to operate at multiple voltages and/or frequencies, and to enter turbo mode when available headroom exists (and assuming the processor has not aged to a point at which a turbo mode is no longer available). The various cores may be coupled via an interconnect/bus 916 to a system agent or uncore 920 that includes various components. As seen, the uncore 920 may include a shared cache 924 which may be a last level cache. In addition, the uncore may include an integrated memory controller 928, various interfaces 932 and a power control unit 936.

As shown in FIG. 9, the componentry illustrated in FIG. 6 can be included in one or more of the cores 904, 908, 912 to realize the weakly ordered doorbell disclosed herein.

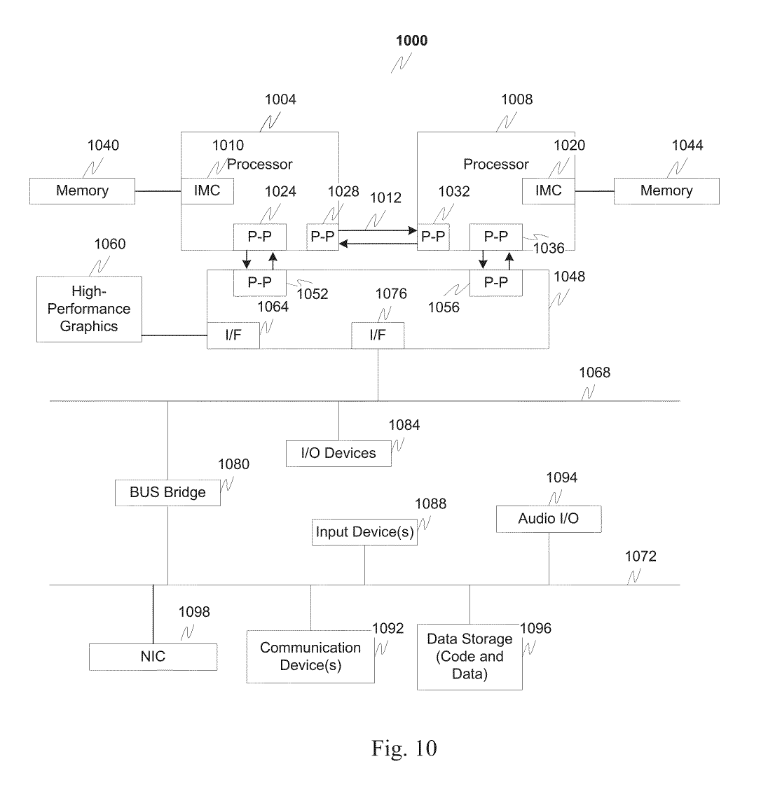

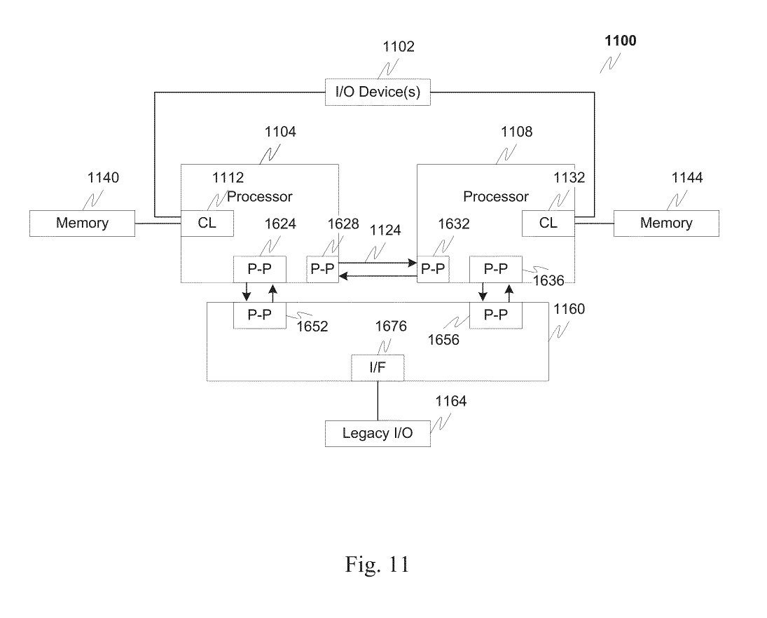

With further reference to FIG. 10, processor 900 may communicate with a system memory 902, e.g., via a memory bus. In addition, via interfaces 932, connection can be made to various off-chip components such as peripheral devices, mass storage and so forth (not shown). While shown with this particular implementation in the embodiment of FIG. 9, the scope of the present disclosure is not limited in this regard.

Embodiments may be implemented in many different system types. Referring now to FIG. 10, a multiprocessor system 1000 is shown in accordance with an implementation. As shown in FIG. 10, multiprocessor system 1000 is a point-to-point interconnect system, and includes a first processor 1004 and a second processor 1008 coupled via a point-to-point interconnect 1012. As shown in FIG. 10, each of processors 1004 and 1008 may be multicore processors, including first and second (or more) processor cores, although potentially many more cores may be present in the processors. The processors each may include hybrid write mode logic in accordance with an embodiment of the present disclosure. In some embodiments, the various components illustrated herein may be implemented the multiprocessor system 1000. For example, memory execution cluster, ARR, FSFSM, etc., may be implemented in the processor 1004 and/or the processor 1008 and associated memory/cache.

While shown with two processors 1004, 1008, it is to be understood that the scope of the present disclosure is not so limited. In other implementations, one or more additional processors may be present.

Processors 1004 and 1008 are shown including integrated memory controller units 1016 and 1020, respectively. Processor 1004 also includes as part of its bus controller units point-to-point (P-P) interfaces 1024 and 1028. Similarly, the second processor 1008 includes P-P interfaces 1032 and 1036. Processors 1004, 1008 may exchange information via a point-to-point (P-P) interface 1012 using P-P interface circuits 1028, 1032. As shown in FIG. 10, IMCs 1016 and 1020 couple the processors to respective memories, namely a memory 1040 and a memory 1044, which may be portions of main memory locally attached to the respective processors.

Processors 1004, 1008 may each exchange information with a chipset 1048 via individual P-P interfaces 1052, 1056 using point to point interface circuits 1024, 1052, 1036, 1056. Chipset 1048 may also exchange information with a high-performance graphics circuit 1060 via a high-performance graphics interface 1064.

A shared cache (not shown) may optionally be included in either processor or outside of both processors, yet connected with the processors via, for example, the P-P interconnect, such that either or both processors' local cache information may be stored in the shared cache if a processor is placed into, for example, a low power mode.

Chipset 1048 may be coupled to a first bus 1068 via an interface 1076. In one embodiment, first bus 1068 may be a Peripheral Component Interconnect (PCI) bus, or a bus such as a PCI Express bus or another third generation or later I/O interconnect bus, although the scope of the present disclosure is not so limited.

As shown in FIG. 10, various I/O devices 1084 may be coupled to the first bus 1068, along with a bus bridge 1080 which couples first bus 1068 to a second bus 1072. In one embodiment, the second bus 1072 may be a low pin count (LPC) bus. Various devices may be coupled to second bus 1072 including, for example, a keyboard and/or mouse or other input device 1088, communication devices 1092 and a storage unit 1096 such as a disk drive or other mass storage device which may include instructions/code and data, in one embodiment. Further, an audio I/O 1094 may be coupled to second bus 1072 as well as a network interface card 1098. Note that other architectures are possible. For example, instead of the point-to-point architecture of FIG. 10, a system may implement a multi-drop bus or other such architecture.

As shown in FIG. 10, the componentry illustrated in FIG. 6 can be included in one or more of the processors' cores.

FIG. 11 illustrates that the processors 1104, 1108 may include integrated memory and I/O control logic (“CL”) 1112 and 1132, respectively. For at least one embodiment, the CL 1112, 1132 may include integrated memory controller units such as described herein. In addition. CL 1112, 1132 may also include I/O control logic. FIG. 11 illustrates that the memories 1140, 1144 are coupled to the CL 1112, 1132, and that I/O devices 1102 are also coupled to the control logic 1112, 1132. Legacy I/O devices 1164 are coupled to the chipset 1160.

In some embodiments, the memory execution cluster, ARR, FSFSM, and other elements may be implemented in the processor 1104 and/or the processor 1108 and associated memory/cache.

As shown in FIG. 11, the componentry illustrated in FIG. 6 can be included in one or more of the processors' cores.

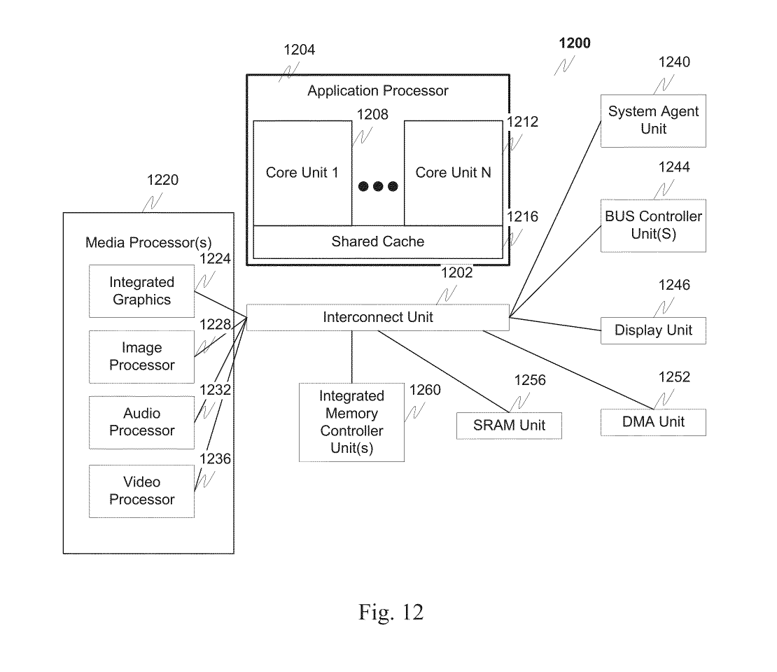

FIG. 12 is an exemplary System on a Chip (SoC) 1200 that may include one or more cores 1208-1212. Other system designs and configurations known in the art for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a large number of systems or electronic devices capable of incorporating a processor and/or other execution logic as disclosed herein are generally suitable.

Referring now to FIG. 12, shown is a diagram of a SoC 1200 in accordance with an embodiment of the present disclosure. In FIG. 12, an interconnect unit(s) 1202 is coupled to: an application processor 1204 which includes a set of one or more cores 1208-1212 and shared cache unit(s) 1216; a system agent unit 1240; a bus controller unit(s) 1244; an integrated memory controller unit(s) 1260; a set or one or more media processors 1220 which may include integrated graphics logic 1224, an image processor 1228 for providing still and/or video camera functionality, an audio processor 1232 for providing hardware audio acceleration, and a video processor 1236 that provides video encode/decode acceleration; a static random access memory (SRAM) unit 1256; a direct memory access (DMA) unit 1252; and a display unit 1246 for coupling to one or more external displays.

As shown in FIG. 12, the componentry illustrated in FIG. 6 can be included in one or more of the cores 1208-12012.

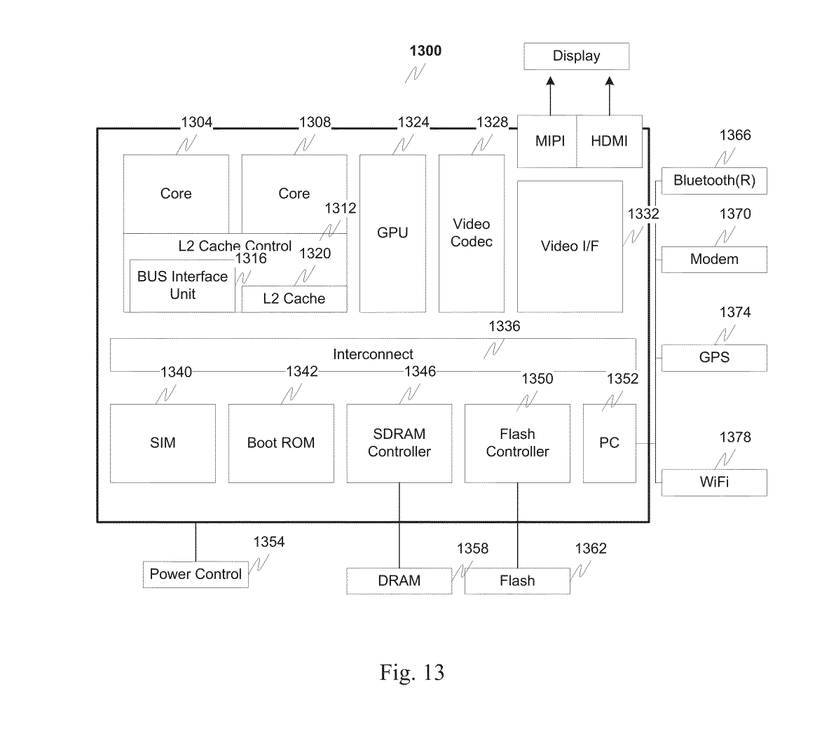

FIG. 13 illustrates an exemplary embodiment of a system on-chip (SOC) design 1300 in accordance with embodiments of the disclosure. As an illustrative example, SOC 1300 is included in user equipment (UE). In one embodiment, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a network.

Here, SOC 1300 includes two cores—1304 and 1308. Similar to the discussion above, cores 1304 and 1308 may conform to an Instruction Set Architecture, such as a processor having the Intel® Architecture Core™, an Advanced Micro Devices®, Inc. (AMD) processor, a MIPS-based processor, an ARM-based processor design, or a customer thereof, as well as their licensees or adopters. Cores 1304 and 1308 are coupled to cache control 1312 that is associated with bus interface unit 1316 and L2 cache 1320 to communicate with other parts of system 1300. Interconnect 1336 includes an on-chip interconnect, such as an IOSF (On-Chip System Fabric), AMBA (Advanced Microcontroller Bus Architecture), or the like, which can implement one or more aspects of the described disclosure.

Interconnect 1336 provides communication channels to the other components, such as a Subscriber Identity Module (SIM) 1340 to interface with a SIM card, a boot ROM 1342 to hold boot code for execution by cores 1304 and 1308 to initialize and boot SOC 1300, an SDRAM controller 1346 to interface with external memory (e.g. DRAM 1358), a flash controller 1350 to interface with non-volatile memory (e.g., flash 1362), a peripheral control 1352 (e.g., Serial Peripheral Interface) to interface with peripherals, video codecs 1328 and Video interface 1332 to display and receive input (e.g., touch enabled input), GPU 1324 to perform graphics related computations, etc. Any of these interfaces may incorporate aspects of the embodiments described herein.

In addition, the system illustrates peripherals for communication, such as a Bluetooth® module 1366, modem 1370, GPS 1374, and WiFi 1378. Note as stated above, a UE can include a radio for communication. As a result, these peripheral communication modules may not all be included. However, in a UE some form of a radio for external communication is generally included.

As shown in FIG. 13, the componentry illustrated in FIG. 6 can be associated with one or more of the cores 1304/1308.

Exemplary aspects are directed toward:
A processor circuit comprising:
   one or more write combine buffers;
   a processor core adapted to issue a next write after a doorbell and before a globally observable message is received.
Any of the above aspects, further comprising an L1 cache adapted to receive the doorbell and the next write.
Any of the above aspects, further comprising write combine buffer eviction control logic adapted to control operation of the one or more write combine buffers.
Any of the above aspects, further comprising write combine buffer eviction control logic adapted to evict the doorbell.
Any of the above aspects, further comprising write combine buffer eviction control logic adapted to evict the doorbell on an in-die interconnect to an uncore.
Any of the above aspects, wherein the doorbell is routed to a device.
Any of the above aspects, wherein the device is a direct memory access capable device.
Any of the above aspects, wherein the next write is issued before one or more of a writepull, a FastGO, a data message, and an external complete message.
Any of the above aspects, wherein the circuit is included in each core of a multi-core architecture.
Any of the above aspects, wherein instructions for implementing the doorbell include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering. |

A method of operating a processor circuit comprising:
   receiving, at one or more write combine buffers, a doorbell;
   issuing a next write after the doorbell and before a globally observable message is received.
Any of the above aspects, further comprising receiving, at an L1 cache, the doorbell and the next write.
Any of the above aspects, further comprising controlling, through write combine buffer eviction control logic, operation of the one or more write combine buffers.
Any of the above aspects, further comprising evicting the doorbell.
Any of the above aspects, further comprising evicting the doorbell on an in-die interconnect to an uncore.
Any of the above aspects, wherein the doorbell is routed to a device.
Any of the above aspects, wherein the device is a direct memory access capable device.
Any of the above aspects, wherein the next write is issued before one or more of a writepull, a FastGO, a data message, and an external complete message.
Any of the above aspects, wherein the circuit is included in each core of a multi-core architecture.
Any of the above aspects, wherein instructions for implementing the doorbell include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering. |

A processor circuit comprising:
   means for receiving, at one or more write combine buffers, a doorbell;
   means for issuing a next write after the doorbell and before a globally observable message is received.
Any of the above aspects, further comprising means for receiving, at an L1 cache, the doorbell and the next write.
Any of the above aspects, further comprising means for controlling, through write combine buffer eviction control logic, operation of the one or more write combine buffers.
Any of the above aspects, further comprising means for evicting the doorbell.
Any of the above aspects, further comprising means for evicting the doorbell on an in-die interconnect to an uncore.
Any of the above aspects, wherein the doorbell is routed to a device.
Any of the above aspects, wherein the device is a direct memory access capable device.
Any of the above aspects, wherein the next write is issued before one or more of a writepull, a FastGO, a data message, and an external complete message.
Any of the above aspects, wherein the circuit is included in each core of a multi-core architecture.
Any of the above aspects, wherein instructions for implementing the doorbell include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering. |

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a system and/or on the die.

The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exemplary techniques illustrated herein are not limited to the specifically illustrated embodiments but can also be utilized with the other exemplary embodiments and each described feature is individually and separately claimable.

Additionally, the systems, methods and techniques can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. In general, any device capable of implementing a state machine that is in turn capable of implementing the methodology illustrated herein can be used to implement the various protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated system or system component, or the like. The system can also be implemented by physically incorporating the system and/or method into a software and/or hardware system, such as the hardware and software systems of a processor.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, an execution unit may be coupled with a register and/or a decode unit through one or more intervening components. In the figures arrows are used to show connections and couplings.

The term “and/or” may have been used. As used herein, the term “and/or” means one or the other or both (e.g., A and/or B means A or B or both A and B).

In the description herein, specific details have been set forth in order to provide a thorough understanding of the embodiments. However, other embodiments may be practiced without some of these specific details. The scope of the embodiments is not to be determined by the specific examples provided above, but only by the claims below. In other instances, well-known circuits, structures, devices, and operations have been shown in block diagram form and/or without detail and/or omitted in order to avoid obscuring the understanding of the description. Where considered appropriate, reference numerals, or terminal portions of reference numerals, have been repeated among the figures to indicate corresponding or analogous elements, which may optionally have similar or the same characteristics, unless specified or otherwise clearly apparent.

Certain operations may be performed by hardware components, or may be embodied in machine-executable or circuit-executable instructions, that may be used to cause and/or result in a machine, circuit, or hardware component (e.g., a processor(s), core(s), portion of a processor, circuit, etc.) programmed with the instructions performing the operations. The operations may also optionally be performed by a combination of hardware and software. A processor, machine, circuit, or hardware may include specific or particular circuitry or other logic (e.g., hardware potentially combined with firmware and/or software) is operable to execute and/or process the instruction and store a result in response to the instruction.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operable to cause the machine to perform and/or result in the machine performing one or operations, methods, or techniques disclosed herein. The machine-readable medium may store or otherwise provide one or more of the embodiments of the instructions disclosed herein.

In some embodiments, the machine-readable medium may include a tangible and/or non-transitory machine-readable storage medium. For example, the tangible and/or non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like.

Examples of suitable machines include, but are not limited to, a general-purpose processor, a special-purpose processor, an instruction processing apparatus, a digital logic circuit, an integrated circuit, or the like. Still other examples of suitable machines include a computing device or other electronic device that includes a processor, instruction processing apparatus, digital logic circuit, or integrated circuit. Examples of such computing devices and electronic devices include, but are not limited to, desktop computers, laptop computers, notebook computers, tablet computers, netbooks, smartphones, cellular phones, servers, network devices (e.g., routers), Mobile Internet devices (MIDs), media players, smart televisions, nettops, miniature PC, set-top boxes, and video game controllers.

Reference throughout this specification to “one embodiment,” “an embodiment,” “one or more embodiments,” “some embodiments,” for example, indicates that a particular feature may be included in the practice of the technique but is not necessarily required to be. Similarly, in the description, various features are sometimes grouped together in a single embodiment, Figure, or description thereof for the purpose of streamlining the disclosure and aiding in the understanding of various inventive aspects. This method of disclosure, however, is not to be interpreted as reflecting an intention that the techniques herein require more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment.

Although embodiments described herein are describe in relation to processors, such as multicore processors including multiple cores, system agent circuitry, cache memories, and one or more other processing units, understand the scope of the present disclosure is not limited in this regard and embodiments are applicable to other semiconductor devices such as chipsets, graphics chips, memories and so forth. Also, although embodiments described herein are with regard to hardware prefetching, in accordance with an embodiment the system can be used to access data in other devices as well.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the disclosed techniques may be described with respect to a limited number of embodiments, those skilled in the art will appreciate numerous modifications and variations therefrom. It is intended that the appended claims cover all such modifications and variations that fall within the spirit and scope of the present disclosure.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, circuits, or the like. For example, “a plurality of processors” may include two or more processors.

The terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

It is therefore apparent that there have been provided systems and methods for a weakly order doorbell. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A processor circuit comprising:
one or more write combine buffers;
a processor core adapted to issue a next write after a doorbell and before a globally observable message is received.

2. The circuit of claim 1, further comprising an L1 cache adapted to receive the doorbell and the next write.

3. The circuit of claim 1, further comprising write combine buffer eviction control logic adapted to control operation of the one or more write combine buffers.

4. The circuit of claim 1, further comprising write combine buffer eviction control logic adapted to evict the doorbell.

5. The circuit of claim 1, further comprising write combine buffer eviction control logic adapted to evict the doorbell on an in-die interconnect to an uncore.

6. The circuit of claim 1, wherein the doorbell is routed to a device.

7. The circuit of claim 6, wherein the device is a direct memory access capable device.

8. The circuit of claim 1, wherein the next write is issued before one or more of a writepull, a FastGO, a data message, and an external complete message.

9. The circuit of claim 1, wherein the circuit is included in each core of a multi-core architecture.

10. The circuit of claim 1, wherein instructions for implementing the doorbell include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering. |

11. A method of operating a processor circuit comprising:
receiving, at one or more write combine buffers, a doorbell;
issuing a next write after the doorbell and before a globally observable message is received.

12. The method of claim 11, further comprising receiving, at an L1 cache, the doorbell and the next write.

13. The method of claim 11, further comprising controlling, through write combine buffer eviction control logic, operation of the one or more write combine buffers.

14. The method of claim 11, further comprising evicting the doorbell.

15. The method of claim 11, further comprising evicting the doorbell on an in-die interconnect to an uncore.

16. The method of claim 11, wherein the doorbell is routed to a device.

17. The method of claim 16, wherein the device is a direct memory access capable device.

18. The method of claim 11, wherein the next write is issued before one or more of a writepull, a FastGO, a data message, and an external complete message.

19. The method of claim 11, wherein the circuit is included in each core of a multi-core architecture.

20. The method of claim 11, wherein instructions for implementing the doorbell include:

| | | |
|---|---|---|
| Load_1 | <WB> | ; Load data necessary |
| Load_2 | <WB> | ; for descriptor creation |
| Store_A | <WB> | ; Create Descriptor - data |
| Store_B | <WB> | ; dependent on previous loads |
| SFENCE | | ; ensures doorbell cannot pass |
| | | ; out descriptor creation |
| Fast_doorbell | <UC> | ; New Doorbell, write to MMIO mapped as |
| | | ; UC, WC type ordering. |
